(19) United States
(12) Patent Application Publication
(10) Pub. No.: US 2026/0231032 A1
(43) Pub. Date: Aug. 6, 2026

(54) DEVICES AND METHODS OF COMMUNICATION

(71) Applicant: NEC CORPORATION, Tokyo (JP)

(72) Inventors: Rao SHI, Beijing (CN); Lei CHEN, Beijing (CN); Gang WANG, Beijing (CN)

(73) Assignee: NEC Corporation, Tokyo (JP)

(21) Appl. No.: 19/153,093

(22) PCT Filed: Feb. 10, 2023
(86) PCT No.: PCT/CN2023/075490

§ 371 Date: Aug. 1, 2025

(51) Int. Cl. H04W 52/02; H04B 17/318; H04W 76/28

(52) U.S. Cl. CPC H04W 52/0235; H04B 17/328; H04W 76/28

(57) ABSTRACT

Embodiments of the present disclosure relate to devices and methods of communication. In one aspect, a terminal device determines a set of parameters for RRM measurement in a LPWUS mode, the set of parameters being associated with a DRX cycle or a LPWUS cycle. Based on the set of parameters, the terminal device performs the RRM measurement for at least one of a SSB or a reference signal specific to the LPWUS mode. In this way, RRM measurement for a LPWUS mode may be achieved.

### TECHNICAL FIELD

Embodiments of the present disclosure generally relate to the field of telecommunication, and in particular, to methods, devices and computer storage media of communication for mobility management in a lower-power wake-up signal (LPWUS) mode.

### BACKGROUND

Currently, it has been proposed to use main radio to describe a regular communication device performing normal radio resource control (RRC) states and additionally design a LPWUS receiver to monitor a LPWUS for turn-on of the main radio. When a terminal device is not receiving service, the terminal device may enter a LPWUS mode during which the main radio is switched off and the LPWUS receiver is switched on to monitor the LPWUS. However, mobility management in the LPWUS mode is still incomplete and needs to be further developed.

### SUMMARY

In general, embodiments of the present disclosure provide methods, devices and computer storage media of communication for mobility management in a LPWUS mode.

In a first aspect, there is provided a terminal device. The terminal device comprises a processor configured to cause the terminal device to: determine a set of parameters for radio resource management (RRM) measurement in a LPWUS mode, the set of parameters being associated with a discontinuous reception (DRX) cycle or a LPWUS cycle; and perform, based on the set of parameters, the RRM measurement for at least one of a synchronization signal block (SSB) or a reference signal specific to the LPWUS mode.

In a second aspect, there is provided a terminal device. The terminal device comprises a processor configured to cause the terminal device to: receive, from a network device, information related to cell reselection in a LPWUS mode; determine that a signal measurement for a neighboring cell in the LPWUS mode satisfies a first criterion for cell reselection; and determine, based on the information, that no cell reselection to the neighboring cell is performed.

In a third aspect, there is provided a terminal device. The terminal device comprises a processor configured to cause the terminal device to: perform signal measurement on a serving cell in a LPWUS mode; and in accordance with a determination that signal strength of the serving cell does not satisfy a second criterion for cell selection for a period of time, exit the LPWUS mode.

In a fourth aspect, there is provided a method of communication. The method comprises: determining, at a terminal device, a set of parameters for RRM measurement in a LPWUS mode, the set of parameters being associated with a DRX cycle or a LPWUS cycle; and performing, based on the set of parameters, the RRM measurement for at least one of a SSB or a reference signal specific to the LPWUS mode.

In a fifth aspect, there is provided a method of communication. The method comprises: receiving, at a terminal device and from a network device, information related to cell reselection in a LPWUS mode; determining that a signal measurement for a neighboring cell in the LPWUS mode satisfies a first criterion for cell reselection; and determining, based on the information, that no cell reselection to the neighboring cell is performed.

In a sixth aspect, there is provided a method of communication. The method comprises: performing, at a terminal device, signal measurement on a serving cell in a LPWUS mode; and in accordance with a determination that signal strength of the serving cell does not satisfy a second criterion for cell selection for a period of time, exiting the LPWUS mode.

In a seventh aspect, there is provided a computer readable medium having instructions stored thereon. The instructions, when executed on at least one processor, cause the at least one processor to perform the method according to any of the fourth to sixth aspects of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates an example communication network in which some embodiments of the present disclosure can be implemented;

FIG. 1B illustrates an example structure of a terminal device in which some embodiments of the present disclosure can be implemented;

FIG. 1C illustrates a diagram illustrating a LPWUS mechanism in which some embodiments of the present disclosure can be implemented;

FIG. 2 illustrates a schematic diagram illustrating a process for managing RRM measurement according to embodiments of the present disclosure;

FIG. 3A illustrates a schematic diagram illustrating an example time window for turning on a main radio according to embodiments of the present disclosure;

FIG. 3B illustrates a schematic diagram illustrating an example measurement proportion between a SSB and a LPWUS according to embodiments of the present disclosure;

FIG. 4 illustrates a schematic diagram illustrating a process for managing cell reselection according to embodiments of the present disclosure;

FIG. 5 illustrates a schematic diagram illustrating an example determination of cell reselection according to embodiments of the present disclosure;

FIG. 6 illustrates a schematic diagram illustrating a process for managing a LPWUS mode according to embodiments of the present disclosure;

FIG. 7 illustrates an example method of communication implemented at a terminal device in accordance with some embodiments of the present disclosure;

FIG. 8 illustrates another example method of communication implemented at a terminal device in accordance with some embodiments of the present disclosure;

FIG. 9 illustrates still another example method of communication implemented at a terminal device in accordance with some embodiments of the present disclosure; and

FIG. 10 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

As used herein, the term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present disclosure, the term “a connected state” may be interchangeably used with “a RRC_CONNECTED state”, the term “an idle state” may be interchangeably used with “a RRC_IDLE state”, and the term “an inactive state” may be interchangeably used with “a RRC_INACTIVE state”.

In the context of the present disclosure, the term “a LPWUS cycle” may refer to a cycle for monitoring a LPWUS and the term “a DRX cycle” may refer to a cycle for monitoring a paging message. The term “a DRX cycle” may be interchangeably used with “a paging DRX cycle”.

In general, the fifth generation (5G) devices consume tens of milliwatts in RRC idle or inactive state and hundreds of milliwatts in RRC connected state. Designing to prolong battery life is a necessity for improving energy efficiency as well as for better user experience. To meet the battery life requirements, an enhanced discontinuous reception (eDRX) cycle with a large value is expected to be used. The eDRX cycle may result in high latency and thus is not suitable for services with requirements of both long battery life and low latency. For example, in fire detection and extinguishment use case, a long eDRX cycle cannot meet the delay requirements. That is, eDRX is apparently not suitable for latency-critical use cases. Thus, it is expected to study an ultra-low power mechanism that can support low latency, e.g., lower than eDRX latency.

As mentioned above, a LPWUS mode is proposed during which main radio is switched off and a LPWUS receiver is switched on to monitor a LPWUS for turn-on of main radio. However, a solution of mobility management in the LPWUS mode is still incomplete. For example, if there is no SSB in a LPWUS mode, how to perform RRM measurement in a LPWUS mode becomes an issue. In addition, if RRM measurement in a LPWUS mode is performed, UE behavior after the RRM measurement such as cell reselection is still unclear.

Embodiments of the present disclosure provide solutions of communication for mobility management in the LPWUS mode so as to overcome the above and other potential issues. In one aspect, a terminal device may determine a set of parameters for RRM measurement in a LPWUS mode. The set of parameters is associated with a DRX cycle or a LPWUS cycle. Based on the set of parameters, the terminal device may perform the RRM measurement for at least one of a reference signal specific to the LPWUS mode or a SSB. In this way, a RRM measurement in a LPWUS mode may be carried out.

In another aspect, a terminal device may receive, from a network device, information related to cell reselection in a LPWUS mode. Upon determination that a signal measurement for a neighboring cell in the LPWUS mode satisfies a first criterion for cell reselection, the terminal device may determine, based on the information, that no cell reselection to the neighboring cell is performed. In this way, a rule on cell reselection for a LPWUS mode may be defined. Based on the rule, LPWUS mode UE may stay in a camping cell for LPWUS monitoring as much as possible. Thus, more power consumption caused by cell reselection may be avoided.

In still another aspect, a terminal device may perform signal measurement on a serving cell in a LPWUS mode. If signal strength of the serving cell does not satisfy a second criterion for cell selection for a period of time, the terminal device may exit the LPWUS mode. In this way, UE may determine whether to stay in a LPWUS mode based on RRM measurement.

Principles and implementations of the present disclosure will be described in detail below with reference to the figures.

### Example of Communication Network

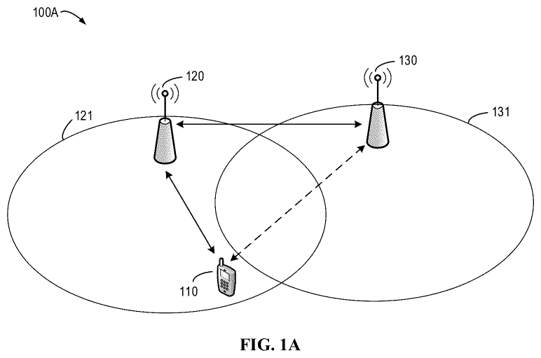

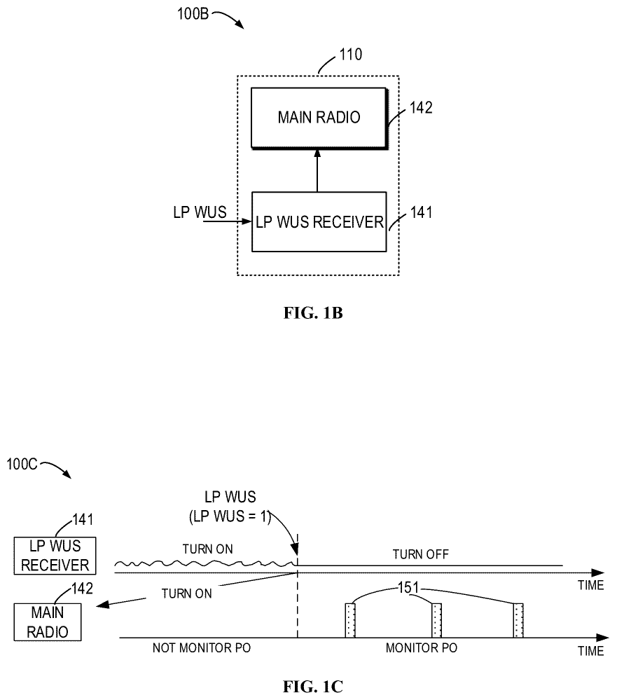

FIG. 1A illustrates a schematic diagram of an example communication network 100A in which some embodiments of the present disclosure can be implemented. As shown in FIG. 1A, the communication network 100A may comprise a terminal device 110 and network devices 120 and 130. The network device 120 may provide a serving cell (also referred to as a cell herein) 121 to serve one or more terminal devices. The network device 130 may also provide a serving cell 131 to serve one or more terminal devices. In this example, the terminal device 110 is shown as being located in the cell 121 and served by the network device 120. In some embodiments, the network devices 120 and 130 may be the same network device. In some embodiments, the network devices 120 and 130 may be different network devices.

As shown in FIG. 1A, the network devices 120 and 130 may communicate with each other via an Xn interface. The terminal device 110 may communicate with the network device 120 or 130 via a Uu interface.

It is to be understood that the number of devices or cells in FIG. 1A is given for the purpose of illustration without suggesting any limitations to the present disclosure. The communication network 100A may include any suitable number of network devices and/or terminal devices and/cells adapted for implementing implementations of the present disclosure.

The communications in the communication network 100A may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

FIG. 1B illustrates a diagram 100B illustrating a terminal device in which some embodiments of the present disclosure can be implemented. For convenience, FIG. 1B is described in connection with the terminal device 110 of FIG. 1A.

As shown in FIG. 1B, the terminal device 110 may comprise a LPWUS receiver 141 and main radio 142. The LPWUS receiver 141 is configured to monitor a LPWUS. The main radio 142 is configured as a regular communication device performing normal radio resource control (RRC) states.

In some embodiments, the LPWUS receiver 141 may detect the LPWUS indicating turn-off of the main radio 142, and trigger the main radio 142 to enter a turn-off or deep-sleep state. In the turn-off or deep-sleep state, the terminal device 110 is not required to process a RRC idle or inactive or connected state procedure. In some embodiments, the LPWUS receiver 141 may detect the LPWUS indicating turn-on of the main radio 142, and trigger the main radio 142 to enter a turn-on state. In the turn-on state, the main radio 142 may monitor paging occasions (POs). More details will be described in connection with FIG. 1C below.

FIG. 1C illustrates a diagram 100C illustrating a LPWUS mechanism in which some embodiments of the present disclosure can be implemented. For convenience, FIG. 1C is described in connection with FIG. 1B. As shown in FIG. 1C, when the terminal device 110 enters a LPWUS mode, the LPWUS receiver 141 may turn on and the main radio 142 may not monitor POs. When the LPWUS receiver 141 detects a LPWUS (for example, WUS=1) indicating turn-on of the main radio 142, the LPWUS receiver 141 triggers the main radio 142 to turn on and the LPWUS receiver 141 turns off. In this case, the main radio 142 may start monitoring POs 151.

Continue to refer to FIG. 1A, in some scenarios, the terminal device 110 may be in a LPWUS mode. The terminal device 110 may move from the cell 121 to the cell 131 in the LPWUS mode. The terminal device 110 may perform RRM measurement for a serving cell and neighboring cells in the LPWUS mode. Based on the RRM measurement, the terminal device 110 may perform mobility management such as cell reselection, e.g., from the cell 121 to the cell 131, or any other suitable actions.

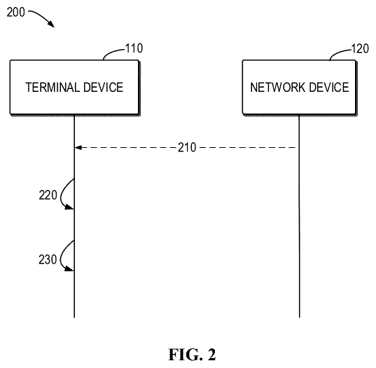

Embodiments of the present disclosure provide solutions of communication for mobility management in a LPWUS mode. The detailed description will be made with reference to FIGS. 2 to 6 below.

### Example Implementation of RRM Measurement Management

FIG. 2 illustrates a schematic diagram illustrating a process 200 for managing RRM measurement according to embodiments of the present disclosure. For the purpose of discussion, the process 200 will be described with reference to FIGS. 1A and 1B. The process 200 may involve the terminal device 110 and the network device 120 as illustrated in FIG. 1A. It is to be understood that the steps and the order of the steps in FIG. 2 are merely for illustration, and not for limitation. For example, the order of the steps may be changed. Some of the steps may be omitted or any other suitable additional steps may be added. It is assumed that the terminal device 110 is in a LPWUS mode.

As shown in FIG. 2, the network device 120 may transmit 210, to the terminal device 110, a DRX configuration and a LPWUS configuration. The DRX configuration may be applied by the main radio 142. The LPWUS configuration may be applied by the LPWUS receiver 141. For example, the DRX configuration may indicate a DRX cycle. The LPWUS configuration may indicate a LPWUS cycle. It is to be understood that the DRX configuration and the LPWUS configuration may further comprise any other suitable information.

With reference to FIG. 2, the terminal device 110 may determine 220 a set of parameters for RRM measurement in a LPWUS mode. In some embodiments, the set of parameters may comprise parameters for serving cell measurement and evaluation such as a time period (denoted as Tₛₑᵣᵥ here) for serving cell measurement and evaluation. In some embodiments, the set of parameters may comprise parameters for intra-frequency measurement and evaluation such as a time period (denoted as T_{detect_Intra} here) for intra-frequency detection, a time period (denoted as T_{measure_Intra} here) for intra-frequency measurement, a time period (denoted as T_{evaluate_Intra} here) for evaluation of cell reselection based on intra-frequency measurement, or a time period (denoted as T_{reselection_Intra} here) for determination of cell reselection based on intra-frequency measurement. In some embodiments, the set of parameters may comprise parameters for inter-frequency measurement and evaluation such as a time period (denoted as T_{detect_Inter} here) for inter-frequency detection, a time period (denoted as T_{measure_Inter} here) for inter-frequency measurement, a time period (denoted as T_{evaluate_Inter} here) for evaluation of cell reselection based on inter-frequency measurement or a time period (denoted as T_{reselection_Inter} here) for evaluation of cell reselection based on inter-frequency measurement.

In some embodiments, the set of parameters may be associated with a DRX cycle. In some embodiments, the set of parameters may be determined based on a length of the DRX cycle. For example, Tₛₑᵣᵥ=M DRX cycles, where M is a positive integer. In another example, T_{detect_Intra}, T_{measure_Intra}, T_{evaluate_Intra} and T_{reselection_Intra} may be determined based on Table 1 below.

TABLE 1

| DRX cycle length | T_{detect}_{_{—}}_{Intra} | Tₘₑₐₛᵤᵣₑ_{_{—}}_{Intra} | Tₑᵥₐₗᵤₐₜₑ_{_{—}}_{Intra} | T_{reselection}_{_{—}}_{Intra} |
|---|---|---|---|---|
| b | T1 × b | T2 × b | T3 × b | T4 × b |

In Table 1, T1, T2, T3 and T4 are factors.

In another example, T_{detect_Intra}, T_{measure_Intra}, T_{evaluate_Intra} and T_{reselection_Intra} may be determined based on Table 2 below.

TABLE 2

| DRX cycle length | T_{detect}_{_{—}}_{Intra} | Tₘₑₐₛᵤᵣₑ_{_{—}}_{Intra} | Tₑᵥₐₗᵤₐₜₑ_{_{—}}_{Intra} | T_{reselection}_{_{—}}_{Intra} |
|---|---|---|---|---|
| b1 | T1 × | T2 × b3(thresh) | T3 × b3(thresh) | T4 × b3(thresh) |
| | b3(thresh) | | | |
| b2 | T1 × | T2 × b3(thresh) | T3 × b3(thresh) | T4 × b3(thresh) |
| | b3(thresh) | | | |
| b3 | T1 × b3 | T2 × b3 | T3 × b3 | T4 × b3 |
| b4 | T1 × b4 | T2 × b4 | T3 × b4 | T4 × b4 |

In Table 2, T1, T2, T3 and T4 are factors. In this example, b1<b2<b3<b4, and a threshold (denoted as thresh) is equal to b3.

In this example, T_{detect_Inter}, T_{measure_Inter}, T_{evaluate_Inter} and T_{reselection_Inter} may be determined in same way as that for T_{detect_Intra}, T_{measure_Intra}, T_{evaluate_Intra} and T_{reselection_Intra}.

In some embodiments, the set of parameters may be associated with a LPWUS cycle. In some embodiments, the set of parameters may be determined based on a length of the LPWUS cycle. For example, Tₛₑᵣᵥ=N LPWUS cycles, where N is a positive integer. In another example, T_{detect_Intra}, T_{measure_Intra}, T_{evaluate_Intra} and T_{reselection_Intra} may be determined based on Table 3 below.

TABLE 3

| LPWUS cycle | | | | |
|---|---|---|---|---|
| length | T_{detect}_{_{—}}_{Intra} | Tₘₑₐₛᵤᵣₑ_{_{—}}_{Intra} | Tₑᵥₐₗᵤₐₜₑ_{_{—}}_{Intra} | T_{reselection}_{_{—}}_{Intra} |
| a | K1 × a | K2 × a | K3 × a | K4 × a |

In Table 3, K1, K2, K3 and K4 are factors.

In another example, T_{detect_Intra}, T_{measure_Intra}, T_{evaluate_Intra} and T_{reselection_Intra} may be determined based on Table 4 below.

TABLE 4

| LPWUS cycle | | | | |
|---|---|---|---|---|
| length | T_{detect}_{_{—}}_{Intra} | Tₘₑₐₛᵤᵣₑ_{_{—}}_{Intra} | Tₑᵥₐₗᵤₐₜₑ_{_{—}}_{Intra} | T_{reselection}_{_{—}}_{Intra} |
| a1 | K1 × a3(thresh) | K2 × a3(thresh) | K3 × a3(thresh) | K4 × a3(thresh) |
| a2 | K1 × a3(thresh) | K2 × a3(thresh) | K3 × a3(thresh) | K4 × a3(thresh) |
| a3 | K1 × a3 | K2 × a3 | K3 × a3 | K4 × a3 |
| a4 | K1 × a4 | K2 × a4 | K3 × a4 | K4 × a4 |

In Table 4, K1, K2, K3 and K4 are factors. In this example, a1<a2<a3<a4, and a threshold (denoted as thresh) is equal to a3.

In this example, T_{detect_Inter}, T_{measure_Inter}, T_{evaluate_Inter} and T_{reselection_Inter} may also be determined in same way as that for T_{detect_Intra}, T_{measure_Intra}, T_{evaluate_Intra} and T_{reselection_Intra}.

Continue to refer to FIG. 2, the terminal device 110 may perform 230, based on the set of parameters, the RRM measurement for at least one of a SSB or a reference signal (also referred to as LPWUS-RS herein) specific to the LPWUS mode. In some embodiments, a SSB may be used for the RRM measurement. For example, the terminal device 110 may perform the RRM measurement for a SSB by turning on the main radio 142. In another example, the terminal device 110 may perform the RRM measurement for a SSB in the LPWUS mode. In some embodiments, a reference signal specific to the LPWUS mode may be introduced for the RRM measurement. For example, the terminal device 110 may perform, in the LPWUS mode, the RRM measurement for the reference signal specific to the LPWUS mode. It is to be understood that the SSB and the reference signal specific to the LPWUS mode may be used in combination for the RRM measurement. For illustration, some example embodiments will be described in connection with Embodiments 1 to 3 below.

### Embodiment 1

In this embodiment, a main radio start requirement is defined for RRM measurement. In some embodiments, the terminal device 110 may determine a time window for turning on the main radio 142 of the terminal device 110, and perform the RRM measurement within the time window. In other words, the terminal device 110 may turn on the main radio 142 during the time window to perform the RRM measurement. It is to be understood that during the time window, the main radio 142 is in a power-on state, an operation state or an active state.

In some embodiments, the set of parameters for the RRM measurement may be associated with the DRX cycle. In this way, legacy RRM measurement scheme may be carried out during the time window. It is to be understood that any other suitable RRM measurement schemes may also be carried out during the time window, and the present disclosure does not limit this aspect.

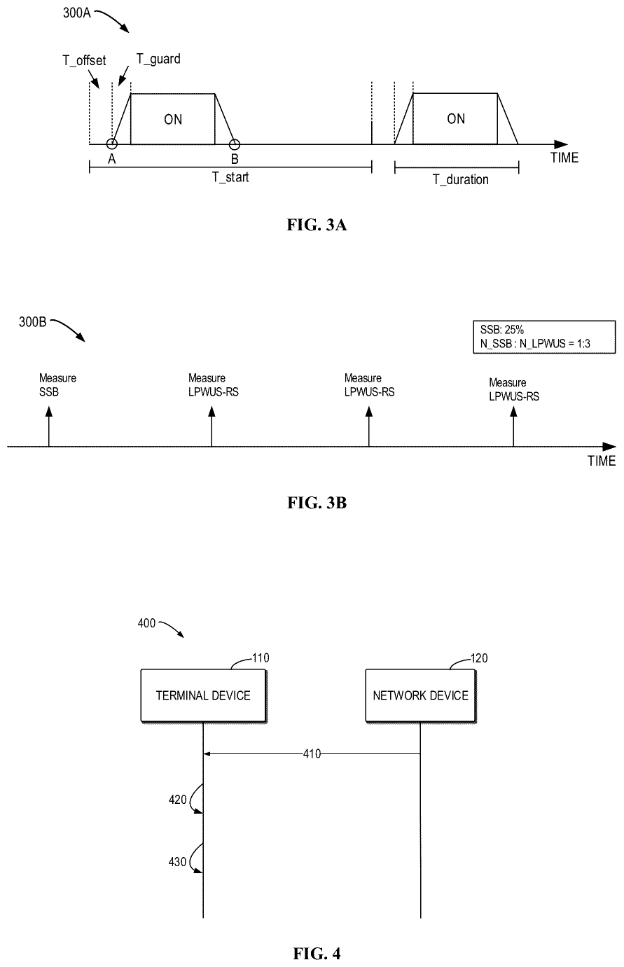

In some embodiments, the terminal device 110 may determine information of the time window. The information of the time window may comprise at least one of the following: a period for turning on the main radio; a duration of the turning on of the main radio; a gap before and after the duration; or an offset to a starting time of the period. FIG. 3A illustrates a schematic diagram 300A illustrating an example time window for turning on a main radio according to embodiments of the present disclosure.

As shown in FIG. 3A, T_start denotes a period for turning on the main radio. The terminal device 110 may need to turn on the main radio 142 every repetition period of T_start. T_offset denotes an offset to a starting time of the period. It is to be understood that T_offset is optional. T_duration denotes a duration of the turning on of the main radio. When the terminal device 110 turns on the main radio, this duration indicates how long the terminal device 110 shall keep the main radio power on until power off of the main radio. T_guard denotes a gap before and after the duration. The terminal device 110 is not expected to perform main radio related action which starts earlier than (the power-on time of the main radio+T_guard), nor perform main radio related action which ends later than (the power-off time of the main radio−T_guard). Alternatively or additionally, the terminal device 110 may not be expected to receive LPWUS during this gap. In the example of FIG. 3A, the main radio 142 of the terminal device 110 may power on at point A and power off at point B.

In some embodiments, the terminal device 110 may determine the information of the time window based on configured information of the time window. That is, the information of the time window may be configured by the network device 120. In some embodiments, the terminal device 110 may determine the information of the time window based on predefined information of the time window. That is, the information of the time window may be predefined.

In some embodiments, the terminal device 110 may determine the information of the time window at least based on a length of the LPWUS cycle. For example, the information of the time window may be determined based on Table 5 below.

TABLE 5

| LPWUS cycle | | | | |
|---|---|---|---|---|
| length | T_start | T_duration | T_offset | T_guard |
| a | L1 × a | L2 × a | configured | configured or |
| | | | | predefined |

In Table 5, L1 and L2 are factors.

In some embodiments, the terminal device 110 may determine the information of the time window at least based on the length of the LPWUS cycle and a threshold length for the LPWUS cycle. For example, the information of the time window may be determined based on Table 6 below.

TABLE 6

| LPWUS cycle | | | | |
|---|---|---|---|---|
| length | T_start | T_duration | T_offset | T_guard |
| a1 | L1 × a3(thresh) | L2 × a3(thresh) | configured | configured or |
| | | | | predefined |
| a2 | L1 × a3(thresh) | L2 × a3(thresh) | configured | configured or |
| | | | | predefined |
| a3 | L1 × a3 | L2 × a3 | configured | configured or |
| | | | | predefined |
| a4 | L1 × a4 | L2 × a4 | configured | configured or |
| | | | | predefined |

In Table 6, L1, L2, L3 and L4 are factors. In this example, a1<a2<a3<a4, and a threshold (denoted as thresh) is equal to a3. If a current LPWUS cycle length (e.g., a1) is below the threshold (e.g., a3), the information of the time window is determined based on the threshold (e.g., a3), as shown in Table 6.

Alternatively, the terminal device 110 may determine the information of the time window at least based on a length of the DRX cycle. For example, For example, the information of the time window may be determined based on Table 7 below.

TABLE 7

| DRX cycle | | | | |
|---|---|---|---|---|
| length | T_start | T_duration | T_offset | T_guard |
| b | M1 × b | M2 × b | configured | configured or |
| | | | | predefined |

In Table 7, M1 and M2 are factors.

In some embodiments, the terminal device 110 may determine the information of the time window at least based on the length of the DRX cycle and a threshold length for the DRX cycle. For example, the information of the time window may be determined based on Table 8 below.

TABLE 8

| DRX cycle | | | | |
|---|---|---|---|---|
| length | T_start | T_duration | T_offset | T_guard |
| b1 | M1 × b3(thresh) | M2 × b3(thresh) | configured | configured or |
| | | | | predefined |
| b2 | M1 × b3(thresh) | M2 × b3(thresh) | configured | configured or |
| | | | | predefined |
| b3 | M1 × b3 | M2 × b3 | configured | configured or |
| | | | | predefined |
| b4 | M1 × b4 | M2 × b4 | configured | configured or |
| | | | | predefined |

In Table 6, M1, M2, M3 and M4 are factors. In this example, b1<b2<b3<b4, and a threshold (denoted as thresh) is equal to b3. If a current LPWUS cycle length (e.g., b1) is below the threshold (e.g., b3), the information of the time window is determined based on the threshold (e.g., b3), as shown in Table 8.

In some embodiments, the terminal device 110 may perform the RRM measurement by at least one of the following: turning on the main radio based on the period for turning on the main radio; causing the main radio to be in a power-on state for the duration; turning on the main radio after the offset from the starting time of the period; or performing the RRM measurement during the power-on state of the main radio.

For illustration, an example procedure is described below.

UE supporting mobility in LPWUS mode shall perform RRM measurement when main radio is power on.

UE shall turn on the main radio transceiver at least every T_start according to the table of MR requirement. And keep the main radio power on for at least T_duration. If T_offset is configured, the UE shall turn on the MR after the offset from the start time.

During power-on state of main radio, the UE perform RRM measurement procedure as legacy.

UE is not expected to perform main radio related action which start earlier than the power-on time of main radio+T_guard, nor perform main radio related action which end later than the power-off time of main radio-T_guard.

Optionally, UE may not be expected to receive LPWUS during this gap T_guard.

In this way, UE may perform SSB based measurement based on main radio start requirement instead of a DRX cycle.

### Embodiment 2

In this embodiment, a LPWUS mode measurement requirement is defined based on a LPWUS cycle. In this embodiment, the set of parameters for RRM measurement is associated with the LPWUS cycle.

In some embodiments, the terminal device 110 may determine number of LPWUS cycles for serving cell measurement. In some embodiments, the terminal device 110 may perform measurement and evaluation on a serving cell at least based on the number of LPWUS cycles.

In some embodiments, the terminal device 110 may determine the number of LPWUS cycles and a threshold length for the LPWUS cycle for the serving cell measurement. In some embodiments, if a length of the LPWUS cycle is below the threshold length, the terminal device 110 may perform the measurement and evaluation on the serving cell at least based on the number of LPWUS cycles and the threshold length.

For example, an example procedure may be described as below.

UE shall measure RSRP and/or RSRQ of SSB/LPWUS-RS of the serving cell and evaluate the cell selection criterion S for the serving cell at least every N×LPWUS cycle. If a threshold is configured and LPWUS cycle<threshold, the UE shall measure the RSRP and/or RSRQ of SSB or LPWUS-RS of the serving cell and evaluate the cell selection criterion S for the serving cell at least every N×threshold.

In some embodiments, the terminal device 110 may determine, based on a length of the LPWUS cycle, a time period for intra-frequency detection, a time period for intra-frequency measurement, and a time period for evaluation or determination of cell reselection based on intra-frequency measurement. In some embodiments, the terminal device 110 may determine, based on the length of the LPWUS cycle and a threshold length for the LPWUS cycle, the time period for intra-frequency detection, the time period for intra-frequency measurement, and the time period for evaluation or determination of cell reselection based on intra-frequency measurement. In some embodiments, the terminal device 110 may determine, based on a length of the LPWUS cycle, a time period for inter-frequency detection, a time period for inter-frequency measurement, and a time period for evaluation or determination of cell reselection based on inter-frequency measurement. In some embodiments, the terminal device 110 may determine, based on the length of the LPWUS cycle and a threshold length for the LPWUS cycle, the time period for inter-frequency detection, the time period for inter-frequency measurement, and the time period for evaluation or determination of cell reselection based on inter-frequency measurement. The requirements for intra-frequency and inter-frequency may be determined as that described above in connection with Tables 3 and 4.

In some embodiments, the terminal device 110 may perform intra-frequency measurement and evaluation by identifying an intra-frequency cell based on the time period for intra-frequency detection; measuring a reference signal from the intra-frequency cell based on the time period for intra-frequency measurement; and evaluating the intra-frequency cell based on the time period for evaluation or determination of cell reselection based on intra-frequency measurement.

For example, an example procedure may be described as below.

UE may identify a possible newly detectable intra-frequency cell based on T_{detect_intra}.

UE shall measure RSRP and/or RSRQ of SSB/LPWUS-RS at least every T_{measure_intra} (according to the table of intra-frequency requirement) for intra-frequency cells that are identified and measured according to measurement rules.

For an intra-frequency cell that has been already detected, but that has not been reselected to, the filtering shall be such that the UE shall be capable of evaluating that the intra-frequency cell has met reselection criterion within T_{evaluate_intra} when T_{reselection_intra}=0.

If T_{reselection_intra} timer has a non zero value and the intra-frequency cell is satisfied with the reselection criteria, the UE shall evaluate this intra-frequency cell for the T_{reselection_intra} time. If this cell remains satisfied with the reselection criteria within this duration, then the UE shall reselect that cell. (This means UE satisfy not only T_{evaluate_intra} but also a subsequent T_{reselection_intra})

In some embodiments, the terminal device 110 may perform inter-frequency measurement and evaluation by identifying an inter-frequency cell based on the time period of for inter-frequency detection; measuring a reference signal from the inter-frequency cell based on the time period for inter-frequency measurement; or evaluating the inter-frequency cell based on the time period for evaluation or determination of cell reselection based on inter-frequency measurement.

For example, an example procedure may be described as below.

UE may identify a possible newly detectable inter-frequency cell based on T_{detect_inter}.

UE shall measure RSRP and/or RSRQ of SSB/LPWUS-RS at least every T_{measure_inter} (according to the table of inter-frequency requirement) for inter-frequency cells that are identified and measured according to measurement rules.

For an inter-frequency cell that has been already detected, but that has not been reselected to, the filtering shall be such that the UE shall be capable of evaluating that the inter-frequency cell has met reselection criterion within T_{evaluate_inter} when T_{reselection_inter}=0.

If T_{reselection_inter} timer has a non-zero value and the inter-frequency cell is satisfied with the reselection criteria, the UE shall evaluate this inter-frequency cell for the T_{reselection_inter} time. If this cell remains satisfied with the reselection criteria within this duration, then the UE shall reselect that cell. (This means UE satisfy not only T_{evaluate_inter} but also a subsequent T_{reselection_inter})

It is to be understood that, this measurement requirement is defined for UE in LPWUS mode performing measurement. Based on this requirement, UE may or may not use main radio to measure SSB, and UE may measure LPWUS-RS in LPWUS mode. There is no need to turn on the main radio during use of the LPWUS-RS.

In this way, UE may perform a SSB based or LPWUS-RS based measurement based on a LPWUS cycle instead of a DRX cycle. This scheme may be more suitable for a LPWUS mode.

### Embodiment 3

In this embodiment, coexistence of a SSB and a LPWUS-RS is considered. For a measured reference signal, the network device 120 may provide, to the terminal device 110, how to perform RRM measurement based on SSB and/or LPWUS-RS.

In some embodiments, the network device 120 may transmit, to the terminal device 110, an indication (denoted as performRRM herein) that the RRM measurement is performed based on priorities of the SSB and the LPWUS-RS. Accordingly, the terminal device 110 may perform the RRM measurement based on the priorities of the SSB and the LPWUS-RS.

In some embodiments, the network device 120 may transmit the indication performRRM in a radio resource control (RRC) reconfiguration message. In some embodiments, the network device 120 may transmit the indication performRRM in a RRC release message. In some embodiments, the network device 120 may transmit the indication performRRM in a paging message. It is to be understood that any other suitable ways are also feasible.

In some embodiments, upon reception of the indication, the terminal device 110 may perform the RRM measurement based on the reference signal in the LPWUS mode firstly. Secondly, the terminal device 110 may perform the RRM measurement based on the SSB in the LPWUS mode. Lastly, the terminal device 110 may perform the RRM measurement based on the SSB by turning on the main radio 142 of the terminal device 110.

For illustration, an example procedure is described as below.

Upon entering LPWUS mode for monitoring LPWUS, the UE shall:

if performRRM is received when entering LPWUS mode, RRM measurement shall be prioritized in accordance with the following order (highest priority listed first):
perform measurement based on LPWUS-RS in LPWUS mode;
perform measurement based on SS/PBCH block (SSB) in LPWUS mode;
perform measurement based on SS/PBCH block (SSB) by turning on main radio.

In some embodiments, the network device 120 may transmit, to the terminal device 110, an indication (denoted as RSType herein) that the RRM measurement is performed based on one of the SSB and the LPWUS. Accordingly, the terminal device 110 may perform the RRM measurement based on the indicated one of the SSB and the LPWUS.

In some embodiments, the network device 120 may transmit the indication RSType in a RRC reconfiguration message. In some embodiments, the network device 120 may transmit the indication RSType in a RRC release message. In some embodiments, the network device 120 may transmit the indication RSType in a paging message. It is to be understood that any other suitable ways are also feasible.

In some embodiments, if the indication RSType is not received, the terminal device 110 may perform the RRM measurement based on predetermined priorities of the SSB and the LPWUS-RS.

For example, the indication RSType may be configured as below.
RSType::=ENUMERATED {ssb, lpwus-rs}
   In this example, if information element (IE) RSType presents, it indicates that which reference signal the UE shall perform measurement. If IE RSType is set to SSB, the UE shall perform measurement based on SSB (may or may not turn on the main radio). If IE RSType is set to LPWUS-RS, the UE shall perform measurement based on LPWUS-RS in LPWUS mode. If IE RSType is absent, UE may perform measurement by implementation or pre-define a default priority (e.g., LPWUS-RS is the first choice).

For illustration, an example procedure is described as below.

Upon entering LPWUS mode for monitoring LPWUS, the UE shall:
1> if RSType is received when entering LPWUS mode:
   2> if the RSType is set to SSB:
      3> perform measurement based on SS/PBCH block according to measurement requirement;
   2> if the RSType is set to LPWUS-RS:
      3> perform measurement based on LPWUS-RS according to measurement requirement;
1> else:
   2> perform measurement based on the default priorities or implementation.

In some embodiments, the network device 120 may transmit, to the terminal device 110, an indication of a measurement proportion between the SSB and the LPWUS. Accordingly, the terminal device 110 may perform the RRM measurement based on the measurement proportion. In some embodiments, the measurement proportion may be c % of SSB. For example, c=25 means 25% for SSB and 75% for LPWUS-RS. Alternatively, the measurement proportion may be d % of LPWUS-RS. For example, d=25 means 75% for SSB and 25% for LPWUS-RS. In some embodiments, the measurement proportion may be N_SSB:N_LPWUS-RS. For example, 1:3 means one of four time for SSB and three of four time for LPWUS-RS. It is to be understood that the indication of the measurement proportion may adopt any other suitable forms.

FIG. 3B illustrates a schematic diagram 300B illustrating an example measurement proportion between a SSB and a LPWUS according to embodiments of the present disclosure. In this example, the measurement proportion is 25% of SSB or 1:3. As shown in FIG. 3B, the terminal device 110 may perform measurement for a SSB once after 3 times measurement for a LPWUS-RS.

For illustration, an example procedure is described as below.

Upon entering LPWUS mode for monitoring LPWUS, the UE shall:
1> if a measurement proportion is received when entering LPWUS mode:
   2> perform measurement between SSB and LPWUS-RS based on the proportion.
      So far, a procedure of RRM measurement for a LPWUS mode is described. With the process 200, RRM measurement for a LPWUS mode may be specified and mobility management in a LPWUS mode may be enhanced.

### Example Implementation of Cell Reselection Management

FIG. 4 illustrates a schematic diagram illustrating a process 400 of managing cell reselection according to embodiments of the present disclosure. For the purpose of discussion, the process 400 will be described with reference to FIG. 1A. The process 400 may involve the terminal device 110 and the network device 120 as illustrated in FIG. 1A. It is to be understood that the steps and the order of the steps in FIG. 4 are merely for illustration, and not for limitation. For example, the order of the steps may be changed. Some of the steps may be omitted or any other suitable additional steps may be added.

As shown in FIG. 4, the network device 120 may transmit 410, to the terminal device 110, information related to cell reselection in a LPWUS mode.

In some embodiments, the information related to cell reselection may comprise an indication (for convenience, also referred to as a first indication herein) that no cell reselection is performed if signal strength (denoted as Srxlev herein) of a serving cell satisfies a criterion (for convenience, also referred to as a second criterion herein) for cell selection. In some embodiments, the second criterion may be an existing S criterion. It is to be understood that any other suitable criterions for cell selection may also be feasible. The first indication is denoted as noNeedForCellReselection herein.

For example, If the indication noNeedForCellReselection is present, the terminal device 110 may not select the new best cell based on an R criterion (or may not perform R criterion rank) as long as the serving cell satisfies the S criterion (or other condition-RangeToBestCell_LPWUS defined below). If the indication noNeedForCellReselection is absent, the terminal device 110 may perform cell reselection as legacy, i.e., select the new best cell.

In some embodiments, the information related to cell reselection may comprise a threshold offset (denoted as RangeToBestCell_LPWUS herein) to signal strength of a neighboring cell. In some embodiments, the neighboring cell may be a cell having the best signal strength in R criterion rank. It is to be understood that the neighboring cell may be any cell to be evaluated. The terminal device 110 may not select the neighboring cell (for example, the best cell based on R criterion rank) as long as a signal strength of the current cell is within RangeToBestCell_LPWUS offset of the neighboring cell.

In this way, a new behavior may be introduced for intra-frequency and equal priority inter-frequency cell reselection criteria. UE may not have to always select the best cell in R criterion (i.e., the first ranked cell).

In some embodiments, the information related to cell reselection may comprise a list of priorities of frequencies specific to the LPWUS mode. For example, the list of priorities of frequencies may be configured as below.

$$FrequencyPriority\_LPWUS \text{::} = INTEGER ( 0 … 7 )$$

In this way, a new criterion may be introduced for inter-frequency cell reselection.

In some embodiments, the list of priorities of frequencies may be provided via system information. In some embodiments, the list of priorities of frequencies may be provided via a RRC release message. It is to be understood that any other suitable ways are also feasible.

In some embodiments, the information related to cell reselection may comprise threshold signal strength (denoted as Thresh_HighP_LPWUS herein) for inter-frequency cell reselection. The threshold signal strength is used to determine that the terminal device 110 needs to select a cell with higher priority inter-frequency if signal strength of a cell is greater than Thresh_HighP_LPWUS.

In some embodiments, the information related to cell reselection may comprise an indication (for convenience, also referred to as a second indication herein) that no cell reselection to a neighboring cell having a priority lower than a priority of the serving cell is performed if the signal strength of the serving cell satisfies the second criterion (e.g., S criterion). The second indication is denoted as noNeedForLowP herein. For example, if the indication noNeedForLowP is present, the terminal device 110 may not perform evaluation of lower priority inter-frequency as long as signal strength of a serving cell satisfies S criterion. That is, the terminal device 110 will not select a lower priority inter-frequency no matter its signal strength.

Continue to refer to FIG. 4, the terminal device 110 may determine 420 that a signal measurement for a neighboring cell in the LPWUS mode satisfies a criterion (for convenience, also referred to as a first criterion herein) for cell reselection. In some embodiments, the first criterion may be an existing R criterion. It is to be understood that any other suitable criterions for cell reselection may also be feasible.

Then the terminal device 110 may determine 430, based on the information, whether cell reselection to the neighboring cell is performed.

In some embodiments where the signal strength of the serving cell satisfies the second criterion, if the first indication noNeedForCellReselection is configured and the threshold offset RangeToBestCell_LPWUS is not configured, the terminal device 110 may determine that the cell reselection to the neighboring cell is not performed.

In some embodiments where the signal strength of the serving cell satisfies the second criterion, if the first indication noNeedForCellReselection is configured and the threshold offset RangeToBestCell_LPWUS is configured, and if an offset between the signal strength of the serving cell and signal strength of the neighboring cell is within the threshold offset RangeToBestCell_LPWUS, the terminal device 110 may determine that the cell reselection to the neighboring cell is not performed.

In some embodiments, if the first indication noNeedForCellReselection is not configured and the threshold offset RangeToBestCell_LPWUS is not configured, the terminal device 110 may perform cell reselection evaluation as legacy, i.e., select the highest ranked cell for cell reselection.

For illustration, an example procedure may be described as below.

If noNeedForCellReselection is configured and RangeToBestCell_LPWUS is not configured, the UE may not perform cell reselection to the highest ranked cell as long as the serving cell fulfil the cell selection criterion S.

If noNeedForCellReselection is configured and RangeToBestCell_LPWUS is configured, the UE may not perform cell reselection to the highest ranked cell as long as the signal strength (Srxlev) of the serving cell is within RangeToBestCell_LPWUS offset of the highest ranked cell.

If neither noNeedForCellReselection nor RangeToBestCell_LPWUS is configured, the UE shall perform cell reselection evaluation as legacy.

In some embodiments, if the list of priorities of frequencies is configured, the terminal device 110 may determine that the cell reselection to the neighboring cell is evaluated based on the list of priorities of frequencies. In some embodiments, if the neighboring cell has a priority higher than a priority of the serving cell and has signal strength higher than the threshold signal strength, the terminal device 110 may determine that the cell reselection to the neighboring cell is performed.

In some embodiments where the neighboring cell has a priority lower than the priority of the serving cell and has the signal strength higher than a first threshold signal strength and a serving cell has the signal strength lower than a second threshold signal strength, if the second indication noNeedForLowP is not configured, the terminal device 110 may determine that cell reselection to the neighboring cell is performed.

In some embodiments where the neighboring cell has a priority lower than the priority of the serving cell and has the signal strength higher than the threshold signal strength and a serving cell has the signal strength lower than a further threshold signal strength, if the second indication noNeedForLowP is configured and the signal strength of the serving cell does not satisfy the second criterion, the terminal device 110 may determine that the cell reselection to the neighboring cell is performed.

For illustration, an example procedure may be described as below.

Upon entering LPWUS mode, the UE shall:

If LPWUS specific frequency priority is provided, determine frequency priority based on the LPWUS specific priority for inter-frequency cell reselection.

Cell reselection to a cell on a higher priority frequency than the serving frequency shall be performed if:
a cell of a higher priority frequency fulfils Srxlev>Thresh_HighP_LPWUS during a time interval T_{reselection_inter},
(optionally) more than 1 second has elapsed since the UE camped on the current serving cell.

Cell reselection to a cell on a lower priority frequency than the serving frequency shall be performed if:
noNeedForLowP is not configured; (or: noNeedForLowP is configured and the serving cell does not satisfy criterion S;)
the serving cell fulfils Srxlev<Thresh_Serving, LowP and a cell of a lower priority frequency fulfils Srxlev>Thresh_X, LowP during a time interval T_{reselection_inter}; and
(optionally) more than 1 second has elapsed since the UE camped on the current serving cell.

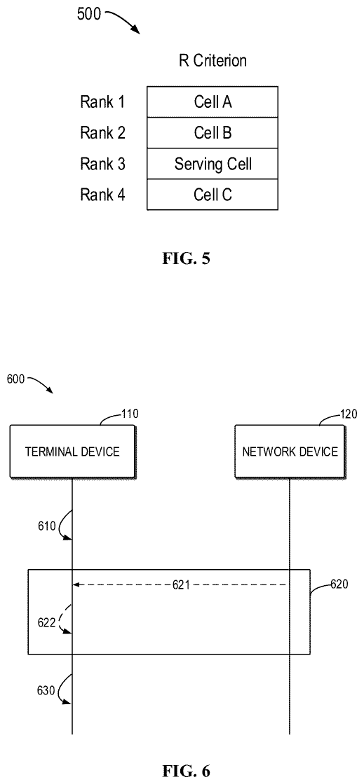

FIG. 5 illustrates a schematic diagram 500 illustrating an example determination of cell reselection according to embodiments of the present disclosure. As shown in FIG. 5, after R criterion rank, cell A is in rank 1, cell B is in rank 2, serving cell is in rank 3, and cell C is in rank 4. Upon determination based on the information related to cell reselection, cell A may not be selected for cell reselection.

With the process 400, a rule of cell reselection for a LPWUS mode is defined. LPWUS mode UE may stay in serving cell for LPWUS monitoring as much as possible and more power consumption caused by cell reselection may be avoided.

### Example Implementation of LPWUS Mode Management

FIG. 6 illustrates a schematic diagram illustrating a process 600 for managing a LPWUS mode according to embodiments of the present disclosure. For the purpose of discussion, the process 600 will be described with reference to FIG. 1A. The process 400 may involve the terminal device 110 and the network device 120 as illustrated in FIG. 1A. It is to be understood that the steps and the order of the steps in FIG. 6 are merely for illustration, and not for limitation. For example, the order of the steps may be changed. Some of the steps may be omitted or any other suitable additional steps may be added.

As shown in FIG. 6, the terminal device 110 may perform 610 signal measurement on a serving cell in a LPWUS mode. It is to be understood that the signal measurement may be performed in any suitable ways and the present disclosure does not limit this aspect.

The terminal device 110 may determine 620 that signal strength of the serving cell does not satisfy a criterion (i.e., the second criterion) for cell selection for a period of time. In some embodiments, the network device 120 may transmit 621, to the terminal device 110, information of the period of time. Alternatively, the terminal device 110 may determine 622 the period of time based on predefined information of the period of time.

In some embodiments, the information of the period of time may comprise a duration. In some embodiments, the information of the period of time may comprise number of LPWUS cycles (denoted as NrofLPWUSCycle herein).

Continue to refer to FIG. 6, upon determination that signal strength of the serving cell does not satisfy the criterion for cell selection for the period of time, the terminal device 110 may exit 630 the LPWUS mode.

For illustration, an example procedure may be described as below.

Network configure UE with a duration—10 s (or could be per-defined) when UE entering a LPWUS mode. In the LPWUS mode, the UE perform RRM measurement based on measurement requirement. If UE performs the measurement of the current cell and the signal strength (e.g., Srxlev) does not satisfy the criterion S for 10 s, the UE shall exit the LPWUS mode and then perform a cell selection procedure.

For illustration, another example procedure may be described as below.

Network configure UE with NrofLPWUSCycle when UE entering a LPWUS mode. In the LPWUS mode, the UE perform RRM measurement based on measurement requirement. If UE perform the measurement of the current cell and the signal strength (e.g., Srxlev) does not satisfy the criterion S for NrofLPWUSCycle LPWUS cycle, the UE shall exit the LPWUS mode and then perform a cell selection procedure.

With the process 600, LPWUS mode UE may determine whether to stay in a LPWUS mode based on RRM measurement results.

It is to be understood that operations in the processes 200, 400 and 600 may be carried out separately or in any suitable combination.

### Example Implementation of Methods

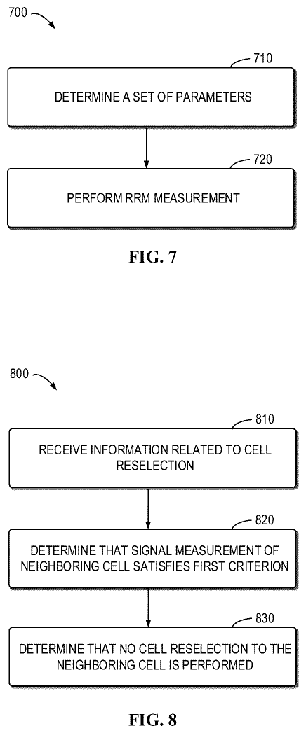

Corresponding to the above processes, embodiments of the present disclosure provide methods of communication implemented at a terminal device. These methods will be described below with reference to FIGS. 7 to 9.

FIG. 7 illustrates an example method 700 of communication implemented at a terminal device in accordance with some embodiments of the present disclosure. For example, the method 700 may be performed at the terminal device 110 as shown in FIG. 1A. For the purpose of discussion, in the following, the method 700 will be described with reference to FIG. 1A. It is to be understood that the method 700 may include additional blocks not shown and/or may omit some blocks as shown, and the scope of the present disclosure is not limited in this regard.

At block 710, the terminal device 110 determines a set of parameters for RRM measurement in a LPWUS mode. The set of parameters is associated with a DRX cycle or a LPWUS cycle.

At block 720, the terminal device 110 performs, based on the set of parameters, the RRM measurement for at least one of a SSB or a reference signal specific to the LPWUS mode.

In some embodiments where the set of parameters is associated with the DRX cycle, the terminal device 110 may perform the RRM measurement by determining a time window for turning on a main radio of the terminal device; and performing the RRM measurement for the SSB within the time window.

In some embodiments, the terminal device 110 may determine the time window by determining information of the time window comprising at least one of the following: a period for turning on the main radio; a duration of the turning on of the main radio; a gap before and after the duration; or an offset to a starting time of the period.

In some embodiments, the terminal device 110 may determine the information of the time window by at least one of the following: determining the information of the time window based on configured information of the time window or predefined information of the time window; determining the information of the time window at least based on a length of the LPWUS cycle; determining the information of the time window at least based on the length of the LPWUS cycle and a threshold length for the LPWUS cycle; determining the information of the time window at least based on a length of the DRX cycle; or determining the information of the time window at least based on the length of the DRX cycle and a threshold length for the DRX cycle.

In some embodiments, the terminal device 110 may perform the RRM measurement by at least one of the following: turning on the main radio based on the period for turning on the main radio; causing the main radio to be in a power-on state for the duration; turning on the main radio after the offset from the starting time of the period; or performing the RRM measurement during the power-on state of the main radio.

In some embodiments where the set of parameters is associated with the LPWUS cycle, the terminal device 110 may determine the set of parameters by at least one of the following: determining number of LPWUS cycles for serving cell measurement; determining the number of LPWUS cycles and a threshold length for the LPWUS cycle for the serving cell measurement; determining, based on a length of the LPWUS cycle, a time period for intra-frequency detection, a time period for intra-frequency measurement, and a time period for evaluation or determination of cell reselection based on intra-frequency measurement; determining, based on the length of the LPWUS cycle and a threshold length for the LPWUS cycle, the time period for intra-frequency detection, the time period for intra-frequency measurement, and the time period for evaluation or determination of cell reselection based on intra-frequency measurement; determining, based on a length of the LPWUS cycle, a time period for inter-frequency detection, a time period for inter-frequency measurement, and a time period for evaluation or determination of cell reselection based on inter-frequency measurement; or determining, based on the length of the LPWUS cycle and a threshold length for the LPWUS cycle, the time period for inter-frequency detection, the time period for inter-frequency measurement, and the time period for evaluation or determination of cell reselection based on inter-frequency measurement.

In some embodiments, the terminal device 110 may perform the RRM measurement by at least one of the following: performing measurement and evaluation on a serving cell at least based on the number of LPWUS cycles; in accordance with a determination that a length of the LPWUS cycle is below the threshold length, performing the measurement and evaluation on the serving cell at least based on the number of LPWUS cycles and the threshold length; identifying an intra-frequency cell based on the time period for intra-frequency detection; measuring a reference signal from the intra-frequency cell based on the time period for intra-frequency measurement; evaluating the intra-frequency cell based on the time period for evaluation or determination of cell reselection based on intra-frequency measurement; identifying an inter-frequency cell based on the time period of for inter-frequency detection; measuring a reference signal from the inter-frequency cell based on the time period for inter-frequency measurement; or evaluating the inter-frequency cell based on the time period for evaluation or determination of cell reselection based on inter-frequency measurement.

In some embodiments, the terminal device 110 may perform the RRM measurement by: receiving, from a network device, an indication that the RRM measurement is performed based on priorities of the SSB and the reference signal; and performing the RRM measurement based on the priorities of the SSB and the reference signal.

In some embodiments, the terminal device 110 may perform the RRM measurement based on the following order: performing the RRM measurement based on the reference signal in the LPWUS mode; performing the RRM measurement based on the SSB in the LPWUS mode; and performing the RRM measurement based on the SSB by turning on a main radio of the terminal device.

In some embodiments, the terminal device 110 may perform the RRM measurement by: receiving, from a network device, an indication that the RRM measurement is performed based on one of the SSB and the LPWUS; and performing the RRM measurement based on the one of the SSB and the LPWUS. In some embodiments, if the indication is not received, the terminal device 110 may perform the RRM measurement based on predetermined priorities of the SSB and the reference signal.

In some embodiments, the terminal device 110 may perform the RRM measurement by: receiving, from the network device 120, an indication of a measurement proportion between the SSB and the LPWUS; and performing the RRM measurement based on the measurement proportion.

With the method 700, RRM measurement for a LPWUS mode may be achieved.

FIG. 8 illustrates another example method 800 of communication implemented at a terminal device in accordance with some embodiments of the present disclosure. For example, the method 800 may be performed at the terminal device 110 as shown in FIG. 1A. It is to be understood that the method 800 may include additional blocks not shown and/or may omit some blocks as shown, and the scope of the present disclosure is not limited in this regard.

At block 810, the terminal device 110 receives, from the network device 120 receive, information related to cell reselection in a LPWUS mode.

At block 820, the terminal device 110 determines that a signal measurement for a neighboring cell in the LPWUS mode satisfies a first criterion for cell reselection.

At block 830, the terminal device 110, based on the information, that no cell reselection to the neighboring cell is performed.

In some embodiments, the information related to cell reselection may comprise at least one of the following: a first indication that no cell reselection is performed if signal strength of a serving cell satisfies a second criterion for cell selection; a threshold offset to signal strength of the neighboring cell; a list of priorities of frequencies specific to the LPWUS mode; a threshold signal strength for inter-frequency cell reselection; or a second indication that no cell reselection to a neighboring cell having a priority lower than a priority of the serving cell is performed if the signal strength of the serving cell satisfies the second criterion.

In some embodiments where the signal strength of the serving cell satisfies the second criterion, if the first indication is configured and the threshold offset is not configured, the terminal device 110 may determine that no cell reselection to the neighboring cell is performed. In some embodiments where the signal strength of the serving cell satisfies the second criterion, if the first indication is configured and the threshold offset is configured, and if an offset between the signal strength of the serving cell and signal strength of the neighboring cell is within the threshold offset, the terminal device 110 may determine that no cell reselection to the neighboring cell is performed.

In some embodiments, if the list of priorities of frequencies is configured, the terminal device 110 may determine that the cell reselection to the neighboring cell is evaluated based on the list of priorities of frequencies. In some embodiments, if the neighboring cell has a priority higher than a priority of the serving cell and has signal strength higher than the threshold signal strength, the terminal device 110 may determine that the cell reselection to the neighboring cell is performed.

In some embodiments, if the neighboring cell has a priority lower than the priority of the serving cell and has the signal strength higher than a first threshold signal strength and the serving cell has the signal strength lower than a second threshold signal strength, and if the second indication is not configured, the terminal device 110 may determine that cell reselection to the neighboring cell is performed.

In some embodiments, if the neighboring cell has a priority lower than the priority of the serving cell and has the signal strength higher than the first threshold signal strength and the serving cell has the signal strength lower than a second threshold signal strength, and if the second indication is configured and the signal strength of the serving cell does not satisfy the second criterion, the terminal device 110 may determine that the cell reselection to the neighboring cell is performed.

With the method 800, cell reselection for a LPWUS mode may be managed.

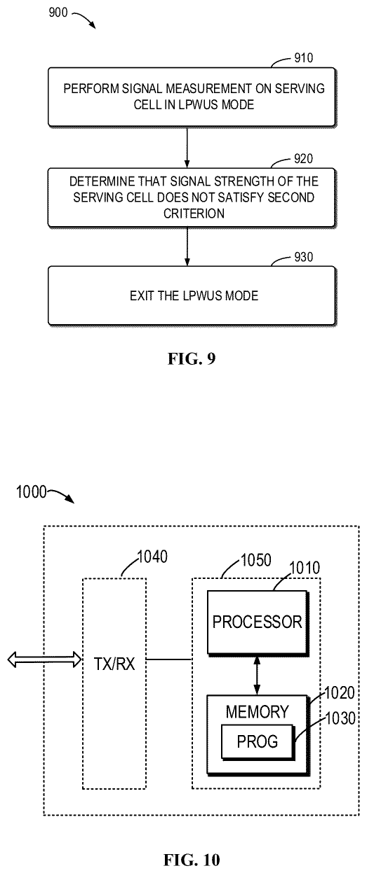

FIG. 9 illustrates another example method 900 of communication implemented at a terminal device in accordance with some embodiments of the present disclosure. For example, the method 900 may be performed at the terminal device 110 as shown in FIG. 1A. For the purpose of discussion, in the following, the method 900 will be described with reference to FIG. 1A. It is to be understood that the method 900 may include additional blocks not shown and/or may omit some blocks as shown, and the scope of the present disclosure is not limited in this regard.

At block 910, the terminal device 110 may perform signal measurement on a serving cell in a LPWUS mode.

At block 920, the terminal device 110 may determine that signal strength of the serving cell does not satisfy a second criterion for cell selection for a period of time.

In some embodiments, the terminal device 110 may receive, from the network device 120, information of the period of time. In some embodiments, the information of the period of time may comprise a duration. In some embodiments, the information of the period of time may comprise number of LPWUS cycles.

At block 930, the terminal device 110 may exit the LPWUS mode.

With the method 900, a LPWUS mode may be managed based on RRM measurement results.

It is to be understood that operations of the methods 700 to 900 correspond to the processes described in connection with FIGS. 2 to 6, and thus other details are omitted here for concise.

### Example Implementation of Device and Apparatus

FIG. 10 is a simplified block diagram of a device 1000 that is suitable for implementing embodiments of the present disclosure. The device 1000 can be considered as a further example implementation of the terminal device 110 or the network device 120 or 130 as shown in FIG. 1A. Accordingly, the device 1000 can be implemented at or as at least a part of the terminal device 110 or the network device 120 or 130.

As shown, the device 1000 includes a processor 1010, a memory 1020 coupled to the processor 1010, a suitable transmitter (TX) and receiver (RX) 1040 coupled to the processor 1010, and a communication interface coupled to the TX/RX 1040. The memory 1010 stores at least a part of a program 1030. The TX/RX 1040 is for bidirectional communications. The TX/RX 1040 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1030 is assumed to include program instructions that, when executed by the associated processor 1010, enable the device 1000 to operate in accordance with the embodiments of the present disclosure, as discussed herein with reference to FIGS. 1A to 9. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means 1050 adapted to implement various embodiments of the present disclosure.

The memory 1020 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

In some embodiments, a terminal device comprises a circuitry configured to: determine a set of parameters for RRM measurement in a LPWUS mode, the set of parameters being associated with a DRX cycle or a LPWUS cycle; and perform, based on the set of parameters, the RRM measurement for at least one of a SSB or a reference signal specific to the LPWUS mode.

In some embodiments, a terminal device comprises a circuitry configured to: receive, from a network device, information related to cell reselection in a LPWUS mode; determine that a signal measurement for a neighboring cell in the LPWUS mode satisfies a first criterion for cell reselection; and determine, based on the information, that no cell reselection to the neighboring cell is performed.

In some embodiments, a terminal device comprises a circuitry configured to: perform signal measurement on a serving cell in a LPWUS mode; and in accordance with a determination that signal strength of the serving cell does not satisfy a second criterion for cell selection for a period of time, exit the LPWUS mode.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1A to 9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-19. (canceled)

20. A method performed by a terminal device with a lower power-wake up signal (LP-WUS) receiver, comprising:
performing a serving cell measurement by measuring Reference Signal Received Power (RSRP) and Reference Signal Received Quality (RSRQ) of a synchronization signal once every cycle for a LP-WUS, when the LP-WUS receiver is in ON state, wherein the serving cell measurement is performed by the LP-WUS receiver; and
performing measurements for inter-frequency cells based on a time period for inter-frequency measurement, wherein the time period for inter-frequency measurement depends on a discontinuous reception (DRX) cycle length and a factor, in a case where the terminal device works on frequency range 1 or frequency range 2.

21. The method of claim 20, further comprising:
performing measurements for intra-frequency cells by measuring RSRP and RSRQ of the synchronization signal based on the DRX cycle length and the factor.

22. The method of claim 21, wherein the measurements for intra-frequency cells is performed by a main receiver.

23. The method of claim 20, further comprising:
receiving configuration information for the DRX and the LP-WUS.

24. The method of claim 20, wherein the factor is independent of the frequency range 1 and the frequency range 2.

25. A terminal device with a lower power-wake up signal (LP-WUS) receiver, comprising a processor configured to:
perform a serving cell measurement by measuring Reference Signal Received Power (RSRP) and Reference Signal Received Quality (RSRQ) of a synchronization signal once every cycle for a LP-WUS, when the LP-WUS receiver is in ON state, wherein the serving cell measurement is performed by the LP-WUS receiver; and
perform measurements for inter-frequency cells based on a time period for inter-frequency measurement, wherein the time period for inter-frequency measurement depends on a discontinuous reception (DRX) cycle length and a factor, in a case where the terminal device works on frequency range 1 or frequency range 2.

26. The terminal device of claim 25, wherein the processor is further configured to:
perform measurements for intra-frequency cells by measuring RSRP and RSRQ of the synchronization signal based on the DRX cycle length and the factor.

27. The terminal device of claim 26, wherein the measurements for intra-frequency cells is performed by a main receiver.

28. The terminal device of claim 25, wherein the processor is further configured to:
receive configuration information for the DRX and the LP-WUS.

29. The terminal device of claim 25, wherein the factor is independent of the frequency range 1 and the frequency range 2.
